(19) United States
(12) Patent Application Publication
(10) Pub. No.: US 2026/0031750 A1
(43) Pub. Date: Jan. 29, 2026

(54) MOTOR STARTING CONTROL METHOD, DEVICE AND SYSTEM

(71) Applicant: CRM ICBG(wuxi)Co., ltd., Wuxi (CN)

(72) Inventors: Yafei LI, Wuxi (CN); Xudong ZHAO, Wuxi (CN); Chun HUA, Wuxi (CN)

(73) Assignee: CRM ICBG(wuxi)Co., ltd., Wuxi (CN)

(21) Appl. No.: 18/995,868

(22) PCT Filed: Aug. 9, 2023
(86) PCT No.: PCT/CN2023/112009

§ 371 Date: Jan. 17, 2025

(30) Foreign Application Priority Data
Nov. 10, 2022 (CN) 2022114061999

(51) Int. Cl. H02P 21/34; H02P 21/00; H02P 21/18

(52) U.S. Cl. CPC H02P 21/34; H02P 21/0003; H02P 21/18; H02P 2209/09

(57) ABSTRACT

A motor starting control method, device, and system, the method including: accumulating electrical parameter to obtain accumulated electrical parameter values, which are alternately assigned to a direct-axis electrical parameter and quadrature-axis electrical parameter; accumulating an angular increment to obtain accumulated values of a forced-driving angle; generating a control signal for a motor based on real-time values of the direct-axis electric parameter, quadrature-axis electrical parameter, and forced-driving angle; the control signal drives the motor; repeating said steps until the direct-axis electrical parameter or the quadrature-axis electrical parameter reaches a target electrical parameter, and then continuing accumulating to obtain the accumulated values of the forced-driving angle while forcibly driving the motor based on the corresponding control signal; when the real-time value of the forced-driving angle stays in sync with the rotor angle, the motor completes the startup; the motor is driven by alternately applying two perpendicular forces to the rotor.

### FIELD OF TECHNOLOGY

The present disclosure relates to the field of motor control, in particular it relates to a motor starting control method, device, and system.

### BACKGROUND

Driving a motor requires applying force to the rotor. The effect of the applied force on the rotor varies depending on the rotor's position, and consequently, the performance of the driving motor also varies. As shown in FIGS. 1-2, the angle between the rotor and the applied force is denoted as θ. When 0°<θ≤180°, the applied force drives the rotor clockwise, causing the motor to reverse. As shown in FIGS. 3-4, when 180°<θ≤360°, the applied force drives the rotor counterclockwise, resulting in forward motor rotation. If a direction of the applied force continuously alternates, such alternation will cause motor oscillations, prolonging the startup duration and, in extreme cases, preventing startup altogether.

Current technologies primarily rely on software to control the quadrature-axis reference current of the motor, incrementally increasing the quadrature-axis reference current of the motor from zero to the target current to drive the motor, manifested as applying a force to the rotor. However, due to the difficulty in determining the position of the rotor, the applied force may either drive the motor forward or reverse. The detailed steps are as follows.
(1) Determining the positioning angle and corresponding positioning target current of the to-be-controlled motor, as well as the asynchronous driving time.
(2) Gradually increasing the quadrature-axis reference current from zero to the positioning target current while maintaining the direct-axis reference current at zero, and holding the quadrature-axis reference current at the target value for a preset stabilization time to position the rotor at the desired angle.
(3) Determining the open-loop startup angle of the motor based on the asynchronous driving time.
(4) Using asynchronous driving angles, incrementally increasing from zero to the startup open-loop angle, to participate in the field-oriented control of Park and inverse Park transformations, in order to asynchronously drive the motor.
(5) Once the asynchronous driving angle reaches the startup open-loop angle, controlling the motor operation using a closed-loop method.

FIG. 5 shows an example of an existing forced driving technology for motor startup. The vertical axis represents angles, and the horizontal axis represents sampling points (which can be approximately considered as time). Based on the rotor angle (solid line in FIG. 5) and the forced-driving angle (dashed line in FIG. 5), the angle θ between the rotor and the applied force can be calculated using the formula: θ=rotor angle−(forced-driving angle+90°)+D, where D is determined as follows: when the rotor angle is greater than the forced-driving angle, D=0°; when the rotor angle is less than the forced-driving angle, D=360°.

In FIG. 5, when initially driving the motor, the rotor angle is approximately 270°, and the angle θ between the rotor and the applied force is approximately 180°. The applied force then drives the rotor to rotate clockwise, causing the rotor angle to gradually decrease to 50°, at which point the angle θ between the rotor and the applied force is approximately 200°. The applied force then drives the rotor to rotate counterclockwise, and the rotor angle gradually increases to 60°, at which point the angle θ between the rotor and the applied force is approximately 150°. Then the applied force again drives the rotor to rotate clockwise, and the rotor angle gradually decreases to 0°. The rotation direction of the rotor changes from clockwise to counterclockwise and then back to clockwise, and the rotation direction of the rotor changes continuously after that. Such alternations can cause severe oscillations in the motor. As shown in FIG. 5, although a positive torque is applied to the rotor, the motor tends to rotate in the reverse direction overall, and the motor experiences severe oscillations. This results in a longer motor startup duration, and in some cases, the motor may even fail to start.

The software control method for motor startup in the existing technologies has the following drawbacks:
1) The motor startup duration is relatively long, making the motor unsuitable for applications that require rapid startup.
2) Software calculations consume CPU resources, detrimental to other safety control functions.
3) Startup dead zones exist, preventing the motor from starting under all conditions.

It should be noted that the above introduction to the technical background is only for providing a clear and complete explanation of the technical solution and facilitating understanding by technical personnel in this field. The above technical solutions should not be considered as known to technical personnel in this field simply because they are described in the background section of the present disclosure.

### SUMMARY

In view of the above-described disadvantages of the related technologies, the present disclosure provides a motor starting control method, device, and system, to solve the issues of long startup duration and startup dead zones in motor startup processes in the related technologies.

To achieve the above-mentioned objectives and other related purposes, the present disclosure provides a motor starting control method, and the method includes the following steps:
S1, accumulating an incremental electrical parameter on top of an initial electrical parameter to obtain accumulated electrical parameter values, and alternately assigning the accumulated electrical parameter values to a direct-axis electrical parameter and a quadrature-axis electrical parameter, wherein the direct-axis electrical parameter is positively correlated with progress of a startup duration, the quadrature-axis electrical parameter is positively correlated with the progress of the startup duration; and accumulating an angular increment on top of an initial angle to obtain accumulated values of a forced-driving angle.
S2, generating a control signal for a motor based on a real-time value of the direct-axis electrical parameter, a real-time value of the quadrature-axis electrical parameter, and a real-time value of the forced-driving angle, wherein the control signal drives the motor operation.
S3, repeating S1 and S2 until the direct-axis electrical parameter or the quadrature-axis electrical parameter reaches a target electrical parameter, and then continue accumulating to obtain the accumulated values of the forced-driving angle while forcibly driving the motor based on the corresponding control signal, wherein when the real-time value of the forced-driving angle stays in sync with the rotor angle, the motor completes a startup.

Optionally, the electrical parameter is a voltage or a current.

More optionally, in S2, the step of generating the control signal includes:

Obtaining a PWM duty cycle value based on the real-time direct-axis electrical parameter, the real-time quadrature-axis electrical parameter, and the real-time forced-driving angle.

Generating the control signal based on the PWM duty cycle value.

More optionally, the step of obtaining the PWM duty cycle value includes:

Performing coordinate transformation based on the real-time direct-axis electrical parameter, the real-time quadrature-axis electrical parameter, and the real-time forced-driving angle to obtain a α-axis voltage and a β-axis voltage in a stationary two-phase coordinate system.

Obtaining the PWM duty cycle value based on the α-axis voltage and the β-axis voltage.

To achieve the above-mentioned objectives and other related objectives, the present disclosure provides a motor starting control device, including a parameter unit and a control unit.

The parameter unit is configured to obtain parameter information for driving a motor start and generate a direct-axis electrical parameter, a quadrature-axis electrical parameter, and a forced-driving angle based on the parameter information; wherein the direct-axis electrical parameter is positively correlated with progress of a startup duration, and the quadrature-axis electrical parameter is positively correlated with the progress of the startup duration.

The control unit is configured to generate a control signal for the motor based on a real-time value of the direct-axis electrical parameter, a real-time value of the quadrature-axis electrical parameter, and a real-time value of the forced-driving angle to drive the motor operation and complete a startup.

Optionally, the parameter unit includes a parameter configuration module and a parameter processing module.

The parameter configuration module is configured to obtain the parameter information for driving the motor start.

The parameter processing module is configured to perform accumulation based on electrical parameter information in the parameter information to obtain the direct-axis electrical parameter and the quadrature-axis electrical parameter, and perform accumulation based on angle information in the parameter information to obtain the forced-driving angle.

Optionally, the control unit obtains a PWM duty cycle value based on the real-time value of the direct-axis electrical parameter, the real-time value of the quadrature-axis electrical parameter, the real-time value of the forced-driving angle, and generates the control signal based on the PWM duty cycle value.

To achieve the above-mentioned objectives and other related objectives, the present disclosure provides a motor starting control system including a processor, an angle generator, a motor starting controller, a PWM generator, and a motor.

The processor is used for obtaining and configuring parameter information for driving the motor start.

The angle generator is communicatively connected to the processor and is used for generating a forced-driving angle of the motor based on angle information in the parameter information.

The motor starting controller is connected to the processor and the angle generator, generates a PWM duty cycle value based on electrical parameter information in the parameter information and the forced-driving angle.

The PWM generator is connected to an output end of the motor starting controller, generates a control signal of the motor based on the PWM duty cycle value, and the motor operates and completes a startup based on the control signal.

Optionally, the angle generator comprises a first accumulation circuit, the first accumulation circuit accumulates an angular increment on top of an initial angle to obtain accumulated values of the forced-driving angle.

More optionally, the motor starting controller comprises a second accumulation circuit, a coordinate transformation circuit, and a duty cycle value generation circuit.

The second accumulation circuit receives the electrical parameter information in the parameter information, accumulates an incremental electrical parameter on top of an initial electrical parameter to obtain accumulated electrical parameter values, alternately assigns the accumulated electrical parameter values to a direct-axis electrical parameter and a quadrature-axis electrical parameter, and stops accumulation when the direct-axis electrical parameter or the quadrature-axis electrical parameter reach a respective target value.

The coordinate transformation circuit is connected to the angle generator and an output of the second accumulation circuit and obtains an α-axis voltage and a β-axis voltage under a stationary two-phase coordinate system according to a real-time value of the forced-driving angle, a real-time value of the direct-axis electrical parameter, and a real-time value of the quadrature-axis electrical parameter.

The duty cycle value generation circuit is connected to an output of the coordinate transformation circuit, and obtains the PWM duty cycle value based on the α-axis voltage and the β-axis voltage.

As described above, the motor starting control method, device, and system provided by the present disclosure have the following beneficial effects:

In the presently disclosed motor starting control method, device, and system, the motor is driven in a forced manner by alternately accumulating the direct-axis and quadrature-axis electrical parameters, which is achieved by alternately applying two perpendicular forces to the rotor. This method can shorten the startup duration of the motor, reduce CPU resource usage, and simplify the motor startup process. Additionally, the motor can be started regardless of the initial position of the rotor.

### BRIEF DESCRIPTION OF THE DRAWINGS

FIG. 1 shows a schematic diagram of a positional relationship and a rotor rotation direction when the angle between a motor rotor and an applied force during a motor driving process is between 0° and 90°.

FIG. 2 shows a schematic diagram of a positional relationship and a rotor rotation direction when the angle between a motor rotor and an applied force during a motor driving process is between 90° and 180°.

FIG. 3 shows a schematic diagram of a positional relationship and a rotor rotation direction when the angle between a motor rotor and an applied force during a motor driving process is between 180° and 270°.

FIG. 4 shows a schematic diagram of a positional relationship and a rotor rotation direction when the angle between a motor rotor and an applied force during a motor driving process is between 270° and 360°.

FIG. 5 shows a schematic diagram illustrating a relationship between a rotor angle and a forced-driving angle in an existing motor driving process.

FIG. 6 shows a flowchart illustrating a motor starting control method according to one embodiment of the present disclosure.

FIG. 7 shows a schematic diagram illustrating a relationship between an electrical rotor angle and a forced-driving angle according to one embodiment of the present disclosure.

FIG. 8 shows a schematic structural diagram of a motor starting control system of the present disclosure.

FIG. 9 shows a schematic structural diagram of a motor starting controller according to one embodiment of the present disclosure.

FIG. 10 shows a schematic structural diagram of a motor starting control device according to one embodiment of the present disclosure.

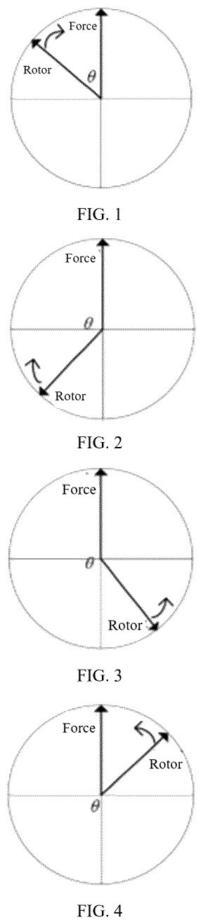

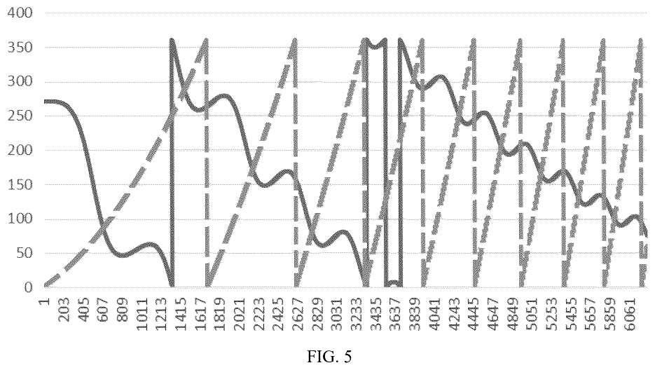

### DETAILED DESCRIPTION

The embodiments of the present disclosure will be described below. Those skilled can easily understand disclosure advantages and effects of the present disclosure according to contents disclosed by the specification. The present disclosure can also be implemented or applied through other different exemplary embodiments. Various modifications or changes can also be made to all details in the specification based on different points of view and applications without departing from the spirit of the present disclosure.

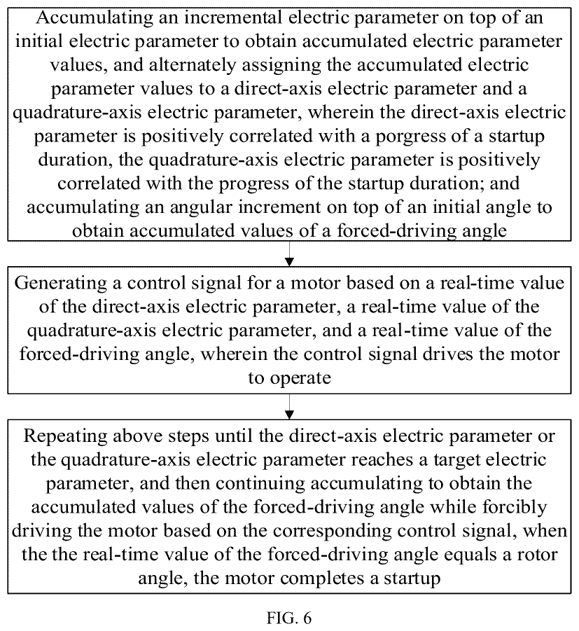

Refer to FIGS. 6-10. It should be noted that the drawings provided in this disclosure only illustrate the basic concept of the present disclosure in a schematic way, so the drawings only show the components closely related to the present disclosure. The drawings are not necessarily drawn according to the number, shape and size of the components in actual implementation; during the actual implementation, the type, quantity and proportion of each component can be changed as needed, and the components' layout may also be more complicated.

In the present disclosure, a motor is driven by alternately accumulating a voltage (or a current) of a direct axis and a quadrature axis, resulting in alternating forces applied to a rotor in two perpendicular directions, which can address an issue in existing technologies where the motor takes too long to start or cannot start at all, thus meeting the needs of applications requiring rapid startup.

### Embodiment 1

The present disclosure provides a motor starting control method, as shown in FIG. 6. The motor starting control method includes the following steps:

S1, accumulating an incremental electrical parameter on top of an initial electrical parameter to obtain accumulated electrical parameter values, and alternately assigning the accumulated electrical parameter values to a direct-axis electrical parameter and a quadrature-axis electrical parameter, wherein the direct-axis electrical parameter is positively correlated with a progress of a startup duration, the quadrature-axis electrical parameter is positively correlated with the progress of the startup duration; and accumulating an angular increment on top of an initial angle to obtain accumulated values of a forced-driving angle.

A direct-axis electrical parameter and a quadrature-axis electrical parameter are generated based on parameter information of a motor, the direct axis and the quadrature axis are perpendicular to each other. Therefore, when the direct-axis electrical parameter and the quadrature-axis electrical parameter alternately control and drive the motor, the direct-axis electrical parameter and the quadrature-axis electrical parameter manifest as two perpendicular forces alternately applied to the motor, specifically applied to a rotor of the motor.

Step S1 generating the direct-axis electrical parameter, the quadrature-axis electrical parameter, and the forced-driving angle includes the following steps:

S11: configuring the parameter information for starting the motor; the parameter information includes angle information, electrical parameter information, and target electrical parameters.

Specifically, the angle information includes the initial angle and the angular increment; the electrical parameter information refers to voltage information or current information, when the electrical parameter information is the voltage information, the electrical parameter information includes an initial voltage and a voltage increment, and the corresponding target electrical parameter is a target voltage; when the electrical parameter information is the current information, the electrical parameter information includes an initial current and a current increment, and the corresponding target electrical parameter is a target current.

S12: obtaining the direct-axis electrical parameter and the quadrature-axis electrical parameter based on electrical parameter information in the parameter information.

Specifically, the process of obtaining the direct-axis electrical parameter and the quadrature-axis electrical parameter from the electrical parameter information in the parameter data includes: (1) obtaining the accumulated electrical parameter values from the electrical parameter information in the parameter data; (2) deriving the direct-axis electrical parameter and the quadrature-axis electrical parameter from the accumulated electrical parameter values.

Specifically, (1) the accumulated electrical parameter values in the present disclosure are dynamically updated as the time proceeds after the motor starts.

Taking the voltage information as an example of the electrical parameter information, the initial voltage is an initial accumulated value, a sum of the initial accumulated value and the voltage increment gives a first accumulated value, and a sum of the first accumulated value and the voltage increment gives the second accumulated value, and so on. The initial accumulated value, the first accumulated value, the second accumulated value, and so on, are sequentially used as a real-time value of the electrical parameter values in the present disclosure.

Specifically, (2) the accumulated electrical parameter values are alternately assigned to the direct-axis electrical parameter and the quadrature-axis electrical parameter; when the real-time value of the accumulated electrical parameter values is assigned to the direct-axis electrical parameter, the corresponding quadrature-axis electrical parameter is zero; when the real-time value of the accumulated electrical parameter values is assigned to the quadrature-axis electrical parameter, the corresponding direct-axis electrical parameter is zero.

S13: generating the forced-driving angle of the motor based on angle information in the parameter information.

Specifically, the forced-driving angle in the present disclosure is dynamically updated based on progress of the motor startup duration; the forced-driving angle at the current moment is a sum of the forced-driving angle from the previous moment and the angular increment, the forced-driving angle at a first moment of the motor startup duration is the initial angle; more specifically, the initial angle is the forced-driving angle at the first moment; a sum of the forced-driving angle at the first moment and the angular increment gives the forced-driving angle at a second moment; a sum of the forced-driving angle at the second moment and the angular increment gives the forced-driving angle at a third moment, wherein values of the forced-driving angle at the first, second, third moments, etc., are sequentially used as a real-time value of the forced-driving angle of the motor.

It should be noted that the initial electrical parameters, electrical parameter increments, initial angle, and angular increments can all be configured as needed, and the user can determine them based on the actual situation. The electrical parameter increment and angular increment can be set as fixed values or variables, depending on requirements.

It should be noted that steps S12 and S13 do not have a fixed order; in practice, steps S12 and S13 may be carried out simultaneously.

S2: generating a control signal for a motor based on a real-time value of the direct-axis electrical parameter, a real-time value of the quadrature-axis electrical parameter, and the real-time value of the forced-driving angle, where the control signal drives the motor operation.

In one embodiment of the present disclosure, an implementation of alternating control of the motor using the real-time direct-axis electrical parameter and the real-time quadrature-axis electrical parameter is as follows: the direct-axis electrical parameter at the first moment control the motor at the first moment, the quadrature-axis electrical parameter at the second moment control the motor at the second moment, and in subsequent moments, the direct-axis electrical parameter and quadrature-axis electrical parameter alternate to control the motor.

Another implementation of alternating control of the motor using the real-time value of the direct-axis electrical parameter and the real-time value of the quadrature-axis electrical parameter is as follows: the quadrature-axis electrical parameter at the first moment controls the motor at the first moment, the direct-axis electrical parameter at the second moment controls the motor at the second moment, and in subsequent moments, the quadrature-axis electrical parameter and the direct-axis electrical parameter alternate to control the motor.

In S2, the process of generating the control signal includes:

S21: obtaining a PWM duty cycle value based on the real-time value of the direct-axis electrical parameter, the real-time value of the quadrature-axis electrical parameter, and the real-time value of the forced-driving angle.

Specifically, obtaining a PWM duty cycle value based on the real-time value of the direct-axis electrical parameter, the real-time value of the quadrature-axis electrical parameter, and the real-time value of the forced-driving angle includes.

First, the real-time value of the forced-driving angle, the real-time value of the direct-axis electrical parameter, and the real-time value of the quadrature-axis electrical parameter are subjected to coordinate transformation to obtain the α-axis and β-axis voltages in a stationary two-phase coordinate system; as an example, the α-axis and β-axis voltages in the stationary two-phase coordinate system are obtained through an inverse Park transformation, then, the PWM duty cycle value is obtained based on the α-axis voltage and the β-axis voltage; as an example, the α-axis voltage and the β-axis voltage in the stationary two-phase coordinate system are then subjected to an inverse Clarke transformation to produce three-phase voltages in a three-phase coordinate system, and the three-phase voltages includes an a-axis voltage, a b-axis voltage, and a c-axis voltage; the three-phase voltages undergo calculation by an SVPWM control algorithm to generate the PWM duty cycle value.

S22: generating the control signal based on the PWM duty cycle value.

Specifically, in one embodiment of the present disclosure, the control signal is a PWM wave, and a driving voltage is applied to the motor through the PWM wave.

S3: repeating S1 and S2 until the direct-axis electrical parameter or the quadrature-axis electrical parameter reaches a target electrical parameter, and then continuing accumulating to obtain the accumulated values of the forced-driving angle while forcibly driving the motor based on the corresponding control signal, wherein when the real-time value of the forced-driving angle stays in sync with the rotor angle, the motor completes a startup.

Specifically, S1 and S2 are repeatedly executed, during which, the direct-axis electrical parameter, the quadrature-axis electrical parameter, and the forced-driving angle are continuously updated (through accumulation); based on the continuously-updated direct-axis electrical parameter, quadrature-axis electrical parameter, and forced-driving angle, corresponding control signals are generated to drive the motor. When the direct-axis electrical parameter or the quadrature-axis electrical parameter reaches the target electrical parameter, the accumulation of the electrical parameters is stopped, no further accumulation is performed; at this point, the values of the direct-axis electrical parameter and quadrature-axis electrical parameter in the control signal are alternately controlled to remain unchanged, while the forced-driving angle continues to accumulate, based on the corresponding control signal, the motor is continuously driven by forced driving. When the forced-driving angle stays in sync with the rotor angle, the operation of the motor is synchronized with the forced driving, the motor completes the startup, and enters a closed-loop control stage.

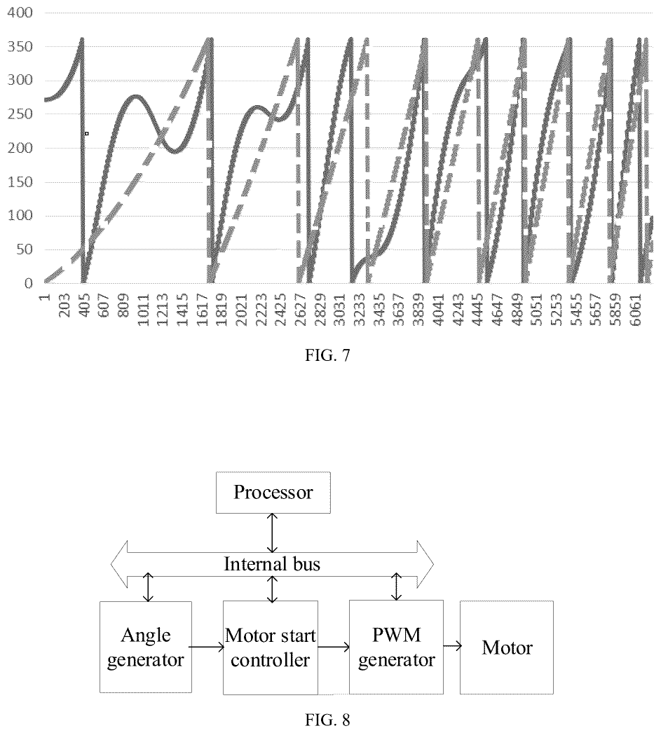

More specifically, FIG. 7 shows a schematic diagram illustrating a relationship between an electrical rotor angle and a forced-driving angle according to one embodiment of the present disclosure, where the vertical axis represents angles, and the horizontal axis represents sampling points (can be approximated as time). Based on the rotor angle (solid line in FIG. 7) and the forced-driving angle (dashed line in FIG. 7), the angle θ_{d} between the rotor and the direct-axis force (i.e., the force applied by the direct-axis electrical parameter) can be calculated using the formula: θ_{d}=rotor angle−forced-driving angle+D; and the angle θ_{q} between the rotor and the quadrature-axis force (i.e., the applied force generated by the quadrature-axis electrical parameter) can be calculated using the formula: θ_{q}=rotor angle−(forced-driving angle+90°)+D, where D is determined as follows: when the rotor angle is greater than the force-driving angle, D=0°; when the rotor angle is less than the force-driving angle, D=360°. As shown in FIG. 7, the rotor angle is about 270° when initially driving the motor, and at this time the angle θ_{d} between the rotor and the direct-axis force is about 90°, the direct-axis force drives the rotor to rotate counterclockwise, and the rotor angle gradually increases to 360°; then the rotor rotates counterclockwise again to 280°, at which time, the angle θ_{d} between the rotor and the direct-axis force is about 130°, the angle θ_{q} between the rotor and the quadrature-axis force is about 40°, the direct-axis force or the quadrature-axis force both drive the rotor to rotate clockwise; then the rotor angle decreases to 195°, at which time the angle θ_{d} between the rotor and the direct-axis force is about 300°, and the angle θ_{d} between the rotor and the quadrature-axis force is about 210°; either the direct-axis force or the quadrature-axis force is dragging the rotor to rotate counterclockwise, and the rotor angle gradually increases to 360°. As shown in FIG. 7, after two oscillations of the rotor, the rotor keeps rotating counterclockwise from the fourth round onwards, the rotor rotates more and more quickly and smoothly, and finally stays in sync with the forced-driving angle, at which point the motor startup is completed. Therefore, the present disclosure can reduce motor oscillations and shorten the motor startup duration, and the motor can be started when the rotor is in any position.

### Embodiment 2

The present disclosure also provides a motor starting control system as shown in FIG. 8, including a processor, an angle generator, a motor starting controller, a PWM generator, and a motor.

The processor is used for obtaining and configuring parameter information used for driving motor startup.

Specifically, the user configures the parameter information via the processor, the parameter information includes angle information, and electrical parameter information (voltage information or current information), and a target electrical parameter (target voltage or target current); as an alternative implementation, the parameter information also includes a PWM duty cycle value.

The angle generator is communicatively connected to the processor and is used for generating a forced-driving angle of the motor based on the angle information in the parameter information.

Specifically, the angle generator processes the forced-driving angle of the motor according to the angle information in the parameter information. The angle generator communicates with the processor through an internal bus in the system. The angle generator receives an initial angle and an angular increment configured by the user, performs a summation process to obtain the forced-driving angle of the motor by summing up the initial angle and the angular increment, and then takes the forced-driving angle of the motor obtained by the summation as a new initial angle and then performs another summation process with the angular increment to obtain another forced-driving angle of the motor; the above process is repeatedly performed, and therefore the forced-driving angle of the present disclosure is also dynamically updated with the progress of the motor startup duration. In one embodiment, the angle generator includes a first accumulation circuit, the first accumulation circuit accumulates an angular increment on top of the initial angle to obtain accumulated values of the forced-driving angle.

The motor starting controller is connected to the processor and the angle generator, generates a PWM duty cycle value based on the electrical parameter information in the parameter information and the forced-driving angle.

Specifically, the motor starting controller is communicatively connected to the processor for obtaining configured electrical parameter information (voltage information or current information); and the motor starting controller is connected to the angle generator for obtaining the forced-driving angle generated by the angle generator; Therefore, the motor starting controller of the present disclosure generates the PWM duty cycle value based on the forced-driving angle generated by the angle generator and user-configured electrical parameter information (voltage information or current information).

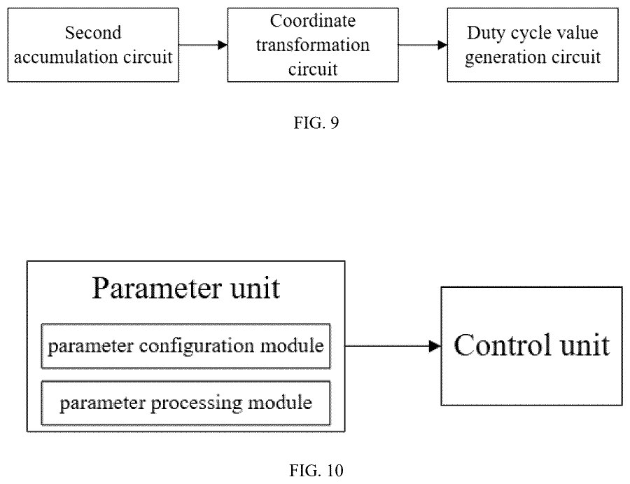

More specifically, as shown in FIG. 9, the motor starting controller includes a second accumulation circuit, a coordinate transformation circuit, and a duty cycle value generation circuit.

The second accumulator circuit receives the electrical parameter information in the parameter information and obtains a direct-axis electrical parameter and a quadrature-axis electrical parameter based on the electrical parameter information.

The coordinate transformation circuit is connected to the angle generator and an output of the second accumulation circuit, and obtains an α-axis voltage and a β-axis voltage under a stationary two-phase coordinate system according to a real-time value of the forced-driving angle, a real-time value of the direct-axis electrical parameter, and a real-time value of the quadrature-axis electrical parameter. As an example, the coordinate transformation circuit is a customized application specific integrated circuit (ASIC) that can perform a coordinate transformation function, or a field programmable gate array (FPGA).

The duty cycle value generation circuit is connected to an output of the coordinate transformation circuit, and obtains the PWM duty cycle value based on the α-axis voltage and the β-axis voltage. As an example, the duty cycle value generation circuit is a customized ASIC that can perform a coordinate transformation function, or a FPGA.

Specifically, (1) the second accumulation circuit obtains accumulated electrical parameter values based on the electrical parameter information in the parameter information; (2) the direct-axis electrical parameter and the quadrature-axis electrical parameter are obtained based on the accumulated electrical parameter values.

In one embodiment of the present disclosure, the accumulated electrical parameter values are obtained by summing the initial voltage and the voltage increment, and then the accumulated electrical parameter values are alternately assigned to the direct-axis electrical parameter and the quadrature-axis electrical parameter. When a real-time value of the accumulated electrical parameter values is assigned to the direct-axis electrical parameter, a corresponding quadrature-axis electrical parameter at this time is zero; when the real-time value of the accumulated electrical parameter values is assigned to the quadrature-axis electrical parameter, the corresponding direct-axis electrical parameter is zero.

The coordinate transformation circuit receives the direct-axis electrical parameter and the quadrature-axis electrical parameter generated by the second accumulation circuit, and the forced-driving angle generated by the angle generator, which are used for an inverse Park transformation to obtain the α-axis voltage and the β-axis voltage in the stationary two-phase coordinate system.

The duty cycle value generation circuit receives the α-axis voltage and the β-axis voltage generated by the coordinate transformation circuit and performs an inverse Clarke transformation to produce three-phase voltages in a three-phase coordinate system, and the three-phase voltages includes an a-axis voltage, a b-axis voltage, and a c-axis voltage; the three-phase voltages undergo calculation by an SVPWM control algorithm to generate the PWM duty cycle value.

The PWM generator is connected to an output end of the motor starting controller, and generates a control signal of the motor based on the PWM duty cycle value, and the motor operates and completes the startup based on the control signal.

Specifically, the PWM generator receives the PWM duty cycle value generated by the motor starting controller, the PWM generator generates a control signal according to the PWM duty cycle value, and the control signal is a PWM wave. The PWM generator first applies a voltage to the motor through the PWM wave, the motor starts to run. When the direct-axis electrical parameter or quadrature-axis electrical parameter reaches the target electrical parameter, the PWM wave continues forcibly driving the motor to synchronize the motor operation with the forced driving until the forced-driving angle stays in sync with the rotor angle, at which point the motor completes the startup; then the motor is closed-loop through closed-loop control.

As an alternative implementation, the motor generates the PWM wave directly based on a user-configured PWM duty cycle value, so that the motor receives the PWM wave generated by the PWM generator and begins startup.

### Embodiment 3

The present disclosure also provides a motor starting control device as shown in FIG. 10, including a parameter unit and a control unit.

The parameter unit is configured to obtain parameter information for driving motor startup and generate a direct-axis electrical parameter, a quadrature-axis electrical parameter, and a forced-driving angle based on the parameter information; wherein the direct-axis electrical parameter is positively correlated with a progress of a startup duration of the motor, and the quadrature-axis electrical parameter is positively correlated with the progress of the startup duration.

Specifically, as shown in FIG. 10, the parameter unit includes a parameter configuration module and a parameter processing module.

The parameter configuration module is configured to obtain the parameter information for driving the motor startup.

More specifically, the user configures parameter information for driving the motor via the processor, the parameter information including angle information, electrical parameter information, and target electrical parameter; as an alternative implementation, the parameter information also includes a PWM duty cycle value.

The parameter processing module is configured to perform accumulation based on electrical parameter information in the parameter information to obtain the direct-axis electrical parameter and the quadrature-axis electrical parameter, and perform accumulation based on angle information in the parameter information to obtain the forced-driving angle.

More specifically, the process of obtaining the direct-axis electrical parameter and the quadrature-axis electrical parameter based on the electrical parameter information in the parameter information includes: (1) accumulating to obtain the accumulated electrical parameter values based on the electrical parameter information in the parameter information; and (2) obtaining the direct-axis electrical parameter and the quadrature-axis electrical parameter based on the accumulated electrical parameter values. The accumulated electrical parameter values in the present disclosure are dynamically updated with the progress of the motor startup duration. Specifically, the direct-axis electrical parameter and the quadrature-axis electrical parameter are obtained by alternately assigning the accumulated electrical parameter values to the direct-axis electrical parameter and the quadrature-axis electrical parameter; when a real-time value of the accumulated electrical parameter values is assigned to the direct-axis electrical parameter, a corresponding quadrature-axis electrical parameter is zero; when the real-time value of the accumulated electrical parameter values is assigned to the quadrature-axis electrical parameter, a corresponding direct-axis electrical parameter is zero.

More specifically, obtaining the forced-driving angle based on the angle information in the parameter information includes: performing accumulation based on the angle information in the parameter information to obtain the forced-driving angle.

The control unit is configured to generate a control signal for the motor based on a real-time value of the direct-axis electrical parameter, a real-time value of the quadrature-axis electrical parameter, and a real-time value of the forced-driving angle to drive the motor until completing the startup.

Specifically, a control signal is first obtained based on the real-time value of the direct-axis electrical parameter, the real-time value of the quadrature-axis electrical parameter, and the real-time value of the forced-driving angle; and then the motor is controlled to start based on the current control signal, and motor startup is completed when the motor operation is synchronized with the forced driving.

More specifically, the PWM duty cycle value is obtained based on the real-time value of the direct-axis electrical parameter, the real-time value of the quadrature-axis electrical parameter, and the real-time value of the forced-driving angle, and the control signal is generated based on the PWM duty cycle value; the control signal is a PWM wave, and the present disclosure applies a voltage to the motor by means of the PWM wave to cause the motor to start, and the PWM wave and the control signal drive the motor to continuously operate until completing the motor startup.

In summary, the present disclosure provides a motor starting control method, device and system, the method includes: accumulating an incremental electric parameter on top of an initial electrical parameter to obtain the accumulated electrical parameter values, and alternately assigning the accumulated electrical parameter values to the direct-axis electrical parameter and the quadrature-axis electrical parameter, the direct-axis electrical parameter is positively correlated with a progress of a startup duration, and the quadrature-axis electrical parameter is positively correlated with the progress of the startup duration; accumulating an angular increment on top of an initial angle to obtain accumulated values of the forced-driving angle; generating a control signal for the motor based on the real-time value of the direct-axis electrical parameter, the real-time value of the quadrature-axis electrical parameter and the real-time value of the forced-driving angle, and the control signal drives the motor to operate; repeating the above steps until the direct-axis electrical parameter or the quadrature-axis electrical parameter reaches the target electrical parameter, continuing accumulating to obtain the accumulated values of the forced-driving angle and forcibly dragging the motor based on the corresponding control signal, and when the real-time value of the forced-driving angle equals the rotor angle, the motor completes a startup; by means of the angular increment, the initial angle is added up to obtain the forced-driving angle, and the motor is forcibly driven. The motor is driven in a forced manner by alternately accumulating the direct-axis electrical parameter and quadrature-axis electrical parameter, which is achieved by alternately applying two perpendicular forces to the rotor. The control method can shorten the startup duration of the motor and reduce the resources occupied by the CPU, and the startup operation is simple, and the motor can be started when the rotor of the motor is in any initial position. Therefore, the present disclosure effectively overcomes various shortcomings in the existing technology and has high industrial utilization value.

The above-mentioned embodiments are merely illustrative of the principle and effects of the present disclosure instead of restricting the scope of the present disclosure. Those skilled in the art can make modifications or changes to the above-mentioned embodiments without going against the spirit and the range of the present disclosure. Therefore, all equivalent modifications or changes made by those who have common knowledge in the art without departing from the spirit and technical concept disclosed by the present disclosure shall be still covered by the claims of the present disclosure.

What is claimed is:

1. A motor starting control method, comprising:
S1, accumulating an incremental electrical parameter on top of an initial electrical parameter to obtain accumulated electrical parameter values, and alternately assigning the accumulated electrical parameter values to a direct-axis electrical parameter and a quadrature-axis electrical parameter, wherein the direct-axis electrical parameter is positively correlated with a progress of a startup duration, the quadrature-axis electrical parameter is positively correlated with the progress of the startup duration; and accumulating an angular increment on top of an initial angle to obtain accumulated values of a forced-driving angle;
S2, generating a control signal for a motor based on a real-time value of the direct-axis electric parameter, a real-time value of the quadrature-axis electrical parameter, and a real-time value of the forced-driving angle, wherein the control signal drives the motor to operate; and
S3, repeating S1 and S2 until the direct-axis electrical parameter or the quadrature-axis electrical parameter reaches a target electrical parameter, and then continuing accumulating to obtain the accumulated values of the forced-driving angle while forcibly driving the motor based on the corresponding control signal, wherein when the real-time value of the forced-driving angle equals a rotor angle, the motor completes a startup.

2. The motor starting control method according to claim 1, wherein the electrical parameter is a voltage or a current.

3. The motor starting control method according to claim 1 or 2, wherein in S2, generating the control signal comprises;
obtaining a PWM duty cycle value based on the real-time value of the direct-axis electrical parameter, the real-time value of the quadrature-axis electrical parameter, and the real-time value of the forced-driving angle; and
generating the control signal based on the PWM duty cycle value.

4. The motor starting control method according to claim 3, wherein obtaining the PWM duty cycle value comprises:
performing coordinate transformation based on the real-time value of the direct-axis electrical parameter, the real-time value of the quadrature-axis electrical parameter, and the real-time value of the forced-driving angle to obtain an α-axis voltage and a β-axis voltage in a stationary two-phase coordinate system; and
obtaining the PWM duty cycle value based on the α-axis voltage and the β-axis voltage.

5. A motor starting control device, comprising a parameter unit and a control unit;
wherein the parameter unit is configured to obtain parameter information for driving a motor start and generate a direct-axis electrical parameter, a quadrature-axis electrical parameter, and a forced-driving angle based on the parameter information; wherein the direct-axis electrical parameter is positively correlated with a progress of a startup duration, and the quadrature-axis electrical parameter is positively correlated with the progress of the startup duration; and
wherein the control unit is configured to generate a control signal for the motor based on a real-time value of the direct-axis electrical parameter, a real-time value of the quadrature-axis electrical parameter, and a real-time value of the forced-driving angle to drive the motor operation and complete a startup.

6. The motor starting control device according to claim 5, wherein the parameter unit comprises a parameter configuration module and a parameter processing module;
wherein the parameter configuration module is configured to obtain the parameter information for driving the motor start; and
wherein the parameter processing module is configured to perform accumulation based on electrical parameter information in the parameter information to obtain the direct-axis electrical parameter and the quadrature-axis electrical parameter, and perform accumulation based on angle information in the parameter information to obtain the forced-driving angle.

7. The motor starting control device according to claim 5, wherein the control unit obtains a PWM duty cycle value based on the real-time value of the direct-axis electrical parameter, the real-time value of the quadrature-axis electrical parameter, the real-time value of the forced-driving angle, and generates the control signal based on the PWM duty cycle value.

8. A motor starting control system, comprising a processor, an angle generator, a motor starting controller, a PWM generator, and a motor;
wherein the processor is used for obtaining and configuring parameter information for driving the motor start;
wherein the angle generator is communicatively connected to the processor and is used for generating a forced-driving angle of the motor based on angle information in the parameter information;
wherein the motor starting controller is connected to the processor and the angle generator, generates a PWM duty cycle value based on electrical parameter information in the parameter information and the forced-driving angle; and
wherein the PWM generator is connected to an output end of the motor starting controller, generates a control signal of the motor based on the PWM duty cycle value, and the motor operates and completes a startup based on the control signal.

9. The motor starting control system according to claim 8, wherein the angle generator comprises a first accumulation circuit, the first accumulation circuit accumulates an angular increment on top of an initial angle to obtain accumulated values of the forced-driving angle.

10. The motor starting control system according to claim 8 or 9, wherein the motor starting controller comprises a second accumulation circuit, a coordinate transformation circuit, and a duty cycle value generation circuit;
wherein the second accumulation circuit receives the electrical parameter information in the parameter information, accumulates an incremental electrical parameter on top of an initial electrical parameter to obtain accumulated electrical parameter values, alternately assigns the accumulated electrical parameter values to a direct-axis electrical parameter and a quadrature-axis electrical parameter, and stops accumulation when the direct-axis electrical parameter or the quadrature-axis electrical parameter reach a respective target value;
wherein the coordinate transformation circuit is connected to the angle generator and an output of the second accumulation circuit, and obtains a α-axis voltage and a β-axis voltage under a stationary two-phase coordinate system according to a real-time value of the forced-driving angle, a real-time value of the direct-axis electrical parameter, and a real-time value of the quadrature-axis electrical parameter; and
wherein the duty cycle value generation circuit is connected to an output of the coordinate transformation circuit, and obtains the PWM duty cycle value based on the α-axis voltage and the β-axis voltage.

11. The motor starting control system according to claim 8, wherein the second accumulation circuit performs summation processing based on an initial voltage and a voltage increment to obtain accumulated electrical parameter values.

12. The motor starting control system according to claim 8, wherein when the second accumulation circuit assigns a real-time value of the accumulated electrical parameter values to the direct-axis electrical parameter, a corresponding quadrature-axis electrical parameter at this time is zero; wherein when the real-time value of the accumulated electrical parameter values is assigned to the quadrature-axis electrical parameter, the corresponding direct-axis electrical parameter is zero.

13. The motor starting control system according to claim 8, wherein the duty cycle value generation circuit receives the α-axis voltage and the β-axis voltage generated by the coordinate transformation circuit and performs inverse Clarke transformation to produce three-phase voltages in a three-phase coordinate system, and the three-phase voltages comprises an a-axis voltage, a b-axis voltage, and a c-axis voltage.

14. The motor starting control system according to claim 13, wherein these three-phase voltages undergo calculation by an SVPWM control algorithm to generate the PWM duty cycle value.

15. The motor starting control system according to claim 8, wherein the control signal generated by the PWM generator based on the PWM duty cycle value is a PWM wave.
